(19) United States
(12) Patent Application Publication
(10) Pub. No.: US 2020/0124903 A1
(43) Pub. Date: Apr. 23, 2020

(54) DISPLAY DEVICE

(71) Applicant: Qingdao Hisense Electronics Co., Ltd., Qingdao (CN)

(72) Inventors: Xiaoguang Yang, Qingdao (CN); Jihang Ma, Qingdao (CN)

(73) Assignee: Qingdao Hisense Electronics Co., Ltd., Qingdao (CN)

(21) Appl. No.: 16/582,598

(22) Filed: Sep. 25, 2019

Related U.S. Application Data
(63) Continuation of application No. PCT/CN2019/083879, filed on Apr. 23, 2019.

(30) Foreign Application Priority Data
Oct. 17, 2018 (CN) 201811210104.X

(51) Int. Cl. G02F 1/1333

(52) U.S. Cl. CPC G02F 1/133308; G02F 2001/133314

(57) ABSTRACT

A display device is provided in the present application. The display device includes: a backplane including a bottom plane and a plurality of side planes, wherein each of the plurality of side planes extends from an edge of the bottom plane to a side of the bottom plane; a plurality of supporting members in at least two corners of the backplane; a liquid crystal panel is positioned on a side of the plurality of supporting members that is away from the bottom plane; an optical component group including a plurality of laminated optical components, and the optical component group is disposed between the liquid crystal panel and the backplane.

### CROSS-REFERENCE TO RELATED APPLICATIONS

The application is a Bypass Continuation Application of PCT/CN2019/083879, filed Apr. 23, 2019, which claims priority to Chinese Patent Application No. 201811210104.X, filed on Oct. 17, 2018 and titled “Display Device”, the contents of all of which are hereby incorporated by reference herein in their entirety.

### TECHNICAL FIELD

The present application relates to the field of liquid crystal display technologies, and in particular, to a display device.

### BACKGROUND

As an essential component of liquid crystal display (LCD), a backlight module is capable of providing sufficient luminance and uniformly distributed light sources, thereby enabling the LCD to function properly. A direct type backlight module generally includes a backplane, optical components, a rubber frame, a liquid crystal panel, a front frame and so on. When fixating both the liquid crystal panel and the optical components with the rubber frame, solutions including the spliced rubber frame, the integrated rubber frame and so on are often used.

### SUMMARY

The present application provides a display device. The display device includes a backplane, an optical component group, a liquid crystal panel, and a plurality of supporting members. The optical component group includes a plurality of laminated optical components. The optical component group is disposed between the liquid crystal panel and the backplane. The backplane includes a bottom plane and a plurality of side planes. Each of the plurality of side planes is extended from an edge of the bottom plane to a side of the bottom plane. The plurality of supporting members are in at least two corners of the backplane. The liquid crystal panel is positioned on a side of the plurality of supporting members that is away from the bottom plane.

The present application provides a display device. The display device includes a backplane, an optical component group, a liquid crystal panel, and a plurality of supporting members. The optical component group includes a plurality of laminated optical components. The optical component group is disposed between the liquid crystal panel and the backplane. The backplane includes a bottom plane and a plurality of side planes. Each of the plurality of side planes is extended from an edge of the bottom plane to a side of the bottom plane. The plurality of supporting members are in at least two corners of the backplane. The liquid crystal panel is on a side of the plurality of supporting members that is away from the bottom plane. The bottom plane includes protrusions close to the plurality of the side planes, wherein the protrusions are protruded toward a light emitting side of the optical component group, and the protrusions are configured to support the optical component group.

### BRIEF DESCRIPTION OF THE DRAWINGS

To describe the embodiments of the present application or solutions in prior art more clearly, a brief description of the drawings for the embodiments of the present application will be given below. It is apparent that the drawings in the description below illustrate some of the embodiments of the present application, and other drawings may be obtained by those of ordinary skill in the art based on these drawings without any creative effort.

FIG. 1 is a schematic diagram of a partial structure of a liquid crystal television with a direct type backlight module according to the related art;

FIG. 2 is a schematic diagram of a partial structure of a display device according to embodiments of the present application;

FIG. 3 is a schematic diagram of a structure of a backplane according to embodiments of the present application;

FIG. 4 is a schematic diagram of a cross section of the backplane according to embodiments of the present application;

FIG. 5 is an assembly schematic diagram and a partially enlarged view of supporting members and the backplane according to embodiments of the present application;

FIG. 6 is a schematic diagram of a structure of a supporting member according to embodiments of the present application;

FIG. 7 is a schematic diagram of a partial structure of the backplane according to embodiments of the present application;

FIG. 8 is a schematic diagram of a cross section of a snapping structure between the supporting member and the backplane according to embodiments of the present application;

FIG. 9 is a schematic diagram of a cross section of a partial structure of the display device according to embodiments of the present application;

FIG. 10 is a schematic diagram of a structure of an optical component group according to embodiments of the present application; and

FIG. 11 is an exploded schematic diagram of the display device according to embodiments of the present application.

### REFERENCE NUMERALS

100—backplane; 200—optical components; 201—diffuser plate; 202—optical film sheets; 300—rubber frame; 400—liquid crystal panel; 500—front frame; 1—backplane; 11—bottom plane; 12—side plane; 111—protrusion; 112—concavity; 121—second snapping portion; 13—hanger; 2—optical component group; 21—reflector; 22—diffusion plate; 23—optical film sheets; 3—liquid crystal panel; 4—supporting member; 41—first extension portion; 42—second extension portion; 43—first snapping portion; 44—first settling surface; 45—supporting portion; 5—front frame.

### DETAILED DESCRIPTION

In order to at least describe the purposes, solutions, and advantages of the embodiments of the present application more clearly, the solutions in the embodiments of the present application are described below in combination with the drawings for the embodiments. It is apparent that the embodiments in the following description are some embodiments but may not be all of the embodiments of the present application. In view of the embodiments in the present application, other embodiments that, for example, may be obtained by a person of ordinary skill in the art without any creative effort, shall fall within the protection scope of the present application.

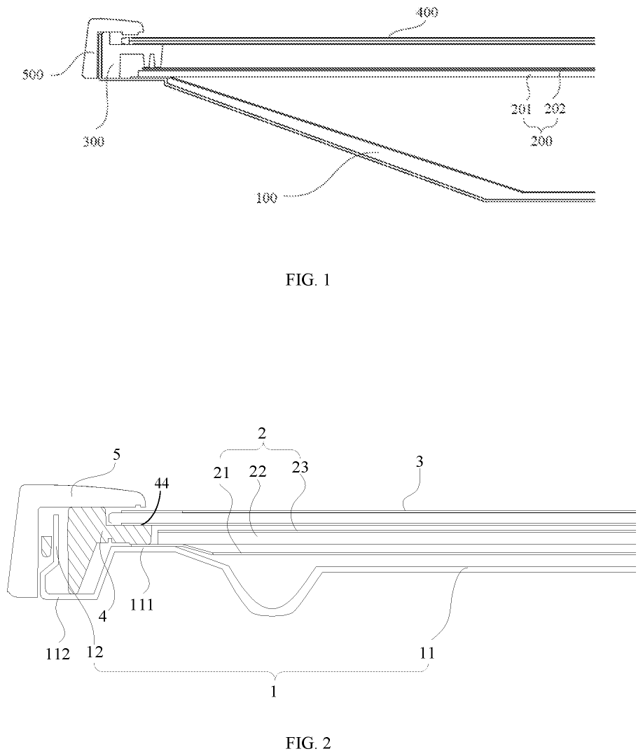

FIG. 1 is a schematic diagram of a partial structure of a liquid crystal television with a direct type backlight module according to the related art. As shown in FIG. 1, the liquid crystal television with said direct type backlight module includes a backplane 100, optical components 200, a rubber frame 300, a liquid crystal panel 400, and a front frame 500. The optical components 200 include a diffusion plate 201 and optical film sheets 202. The backplane 100 is configured to bear the optical components 200 including the diffusion plate 201 and the optical film sheets 202. The rubber frame 300 is located a side of both the liquid crystal panel 400 and the optical components 200. A side of the rubber frame 300 in contact with the liquid crystal panel 400 is configured to bear the liquid crystal panel 400. The opposite side of the rubber frame 300 may be configured to constrain and support the optical components 200. The front frame 500 is connected to the outside of the rubber frame 300 and configured to protect the rubber frame 300.

Conventional approaches like the spliced rubber frame and the integrated rubber frame are used when the liquid crystal panel and optical components are fixed by the rubber frame in related art, where a thickness of a main body of the rubber frame has a direct impact on the overall size of the backlight module, thereby causing a thickness of a display device to be thicker.

In view of this, the present application provides a display device to reduce the thickness of the backlight module, to improve production efficiency of the backlight module and at the same time reduce costs.

FIG. 2 is a schematic diagram of a partial structure of the display device according to embodiments of the present application. As shown in FIG. 2, the display device of the present application includes a backplane 1, an optical component group 2, a liquid crystal panel 3, and supporting members 4. The optical component group 2 includes a plurality of optical components laminated. The backplane 1 includes a bottom plane 11 and side planes 12 each of which extended from an edge of the bottom plane 11 to a side of the bottom plane 11. The supporting members 4 are mounted in corners of the backplane 1. The liquid crystal panel 3 is provided on a side of the supporting members 4 that is away from the bottom plane 11.

In embodiments, the display device may also include a front frame 5, which is connected to the outside of the backplane 1

As shown in FIG. 2, the display device also includes the front frame 5 provided on an edge of the backplane 1, i.e., outside of the side plane 12, and the front frame 5 partially extends to a corresponding edge of the liquid crystal panel 3. By connecting with the side plane 12 of the backplane 1, a part of the supporting member 4, and the liquid crystal panel 3, the front frame 5 integrates the backplane 1, the supporting member 4, the optical component group 2, and the liquid crystal panel 3 into a whole. That is, the front frame 5 integrates various components of the display device into a whole.

The display device according to the present embodiments may be a liquid crystal television or a liquid crystal display and the like. As shown in FIG. 2, from one side of the backplane 1, the display device according to the present embodiments is provided with the optical component group 2, and the liquid crystal panel 3 in sequence. The backplane 1 includes the bottom plane 11 covering a front (backlight) surface of the optical component group 2, and the side plane 12 disposed at a side of the optical component group 2. The display device also includes supporting members 4 which are mounted in the corners of the backplane 1, and the liquid crystal panel 3 is provided on and directly in contact with the supporting members 4, so that the liquid crystal panel is well supported by the supporting members 4. As a partial supporting structure, the supporting member 4 is smaller-sized and occupies less space than an overall supporting structure such as the rubber frame, thereby reducing the thickness of the backlight module in the display device. By using the supporting members 4 in the corners of the liquid crystal panel 3 to take place of the rubber frame that surrounds the liquid crystal panel, less material is used and less cost is paid, and a reduction in the difficulty of assembling is also achieved.

The display device provided by the present embodiments includes the backplane, the optical component group, the liquid crystal panel, and supporting members. The optical component group includes a plurality of optical components laminated, and the optical component group is provided between the liquid crystal panel and the backplane. The backplane includes the bottom plane and the side planes respectively extended from the edge of the bottom plane to the side of the bottom plane. The supporting members are provided in at least two corners of the backplane, and the liquid crystal panel is disposed on a side of the supporting members that is away from the bottom plane. By disposing supporting members in at least two corners of the backplane, the liquid crystal panel is supported and fixed, thereby reducing the thickness of the backlight module in the display device. So, the thickness of the display device is less.

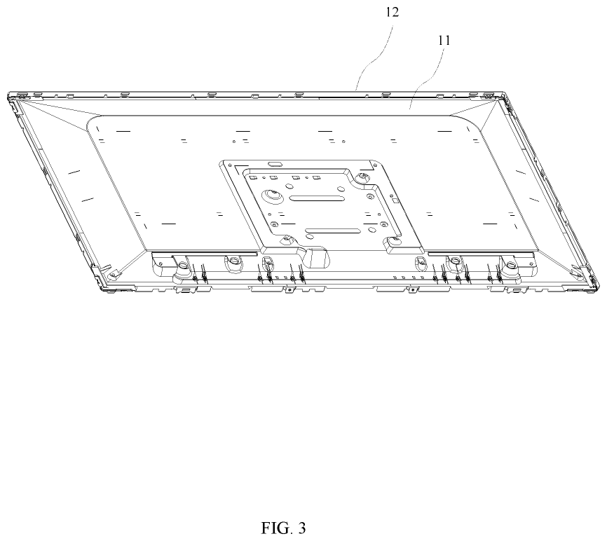

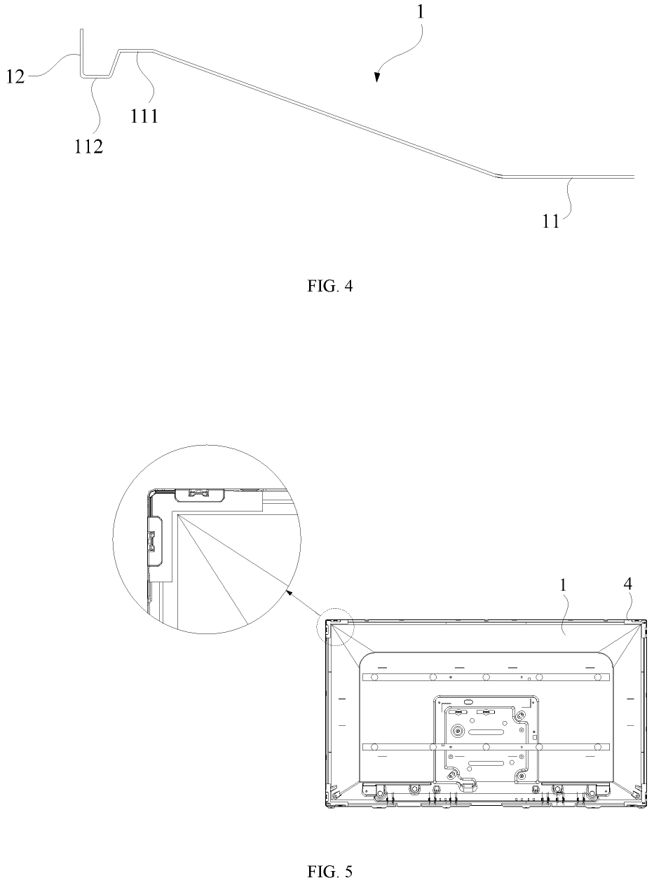

FIG. 3 is a schematic diagram of a structure of the backplane according to embodiments of the present application. FIG. 4 is a schematic diagram of a cross section of a backplane according to embodiments of the present application. As shown in FIG. 3 and FIG. 4, the bottom plane 11 includes a protrusion 111 close to the side plane 12, protruded toward a light emitting side of the optical component group 2 and configured to support the optical component group 2. In this way, the protrusions 111 are disposed on edge portions of the bottom plane 11 and near the side planes 12, and top ends of the protrusions 111 are in contact with the optical component group 2, such that the protrusions 111 are configured to support the whole optical component group 2. Such an arrangement makes it possible for the backplane 1 to directly support the optical component group 2. Meanwhile, due to the bending treatment during the process of manufacturing the backplane 1, compared with the conventional backplane structure, the overall strength of the display device provided by embodiments is improved, thereby solving the inevitable problem of a curved or broken screen due to a limited strength of material. And thus, the reliability of the product is improved while solving structural deformation problems.

In embodiments, a concavity 112 is formed between the protrusion 111 and the side plane 12, that is, the bottom plane 11 further includes the concavity 112 between the protrusion 111 and the side plane 12. The concavity 112 is configured to house the supporting member 4 or any other structure.

In embodiments, in order to secure the liquid crystal panel in all directions, the number of supporting members 4 is generally four, and the supporting members 4 are disposed in one-to-one correspondence with the corners of the backplane 1.

FIG. 5 is an assembly schematic diagram and a partially enlarged view of supporting members and the backplane according to embodiments of the present application. As shown in FIG. 5, four supporting members 4 are respectively mounted in the four corners of the backplane 1. Thus, because the space formed by the four supporting members 4 is able to accommodate both the optical component group 2 and the liquid crystal panel 3, the protrusions 111 of the backplane 1 is configured to support and fixate the optical component group 2, and meanwhile the supporting members 4 are able to provide an auxiliary fixation or constraint for the optical component group 2.

Meanwhile, since the liquid crystal panel 3 is located on the supporting members 4, with four corners of the liquid crystal panel 3 in direct contact with the four supporting members 4, the supporting members 4 is able to fixate the liquid crystal panel 3, and support the liquid crystal panel 3. Therefore, by using four supporting members 4 to fixate the four corners of the liquid crystal panel 3, a better support and fixation are provided to the liquid crystal panel 3, so that a firmer installation and a higher flatness of the liquid crystal panel 3 are achieved.

Furthermore, two supporting members 4 may be used. The two supporting members 4 may be mounted at two of the four corners of the backplane 1 which are centrosymmetric. Due to two set of diagonal corners that are centrosymmetric, the two supporting members 4 need to be disposed by selecting one set of corners. Specifically, details concerning the use of two supporting members 4 are similar to those of using four supporting members 4, which will not be described again.

The supporting members 4 may have several different structures and forms. As a manner, the supporting member 4 includes a first extension portion 41 and a second extension portion 42, which are respectively disposed on two adjacent edge portions of the backplane 1.

As shown in FIG. 5, the supporting member 4 at the corner of the backplane 1 includes two portions. Since the corner portion of the backplane 1 includes two adjacent edge portions at a right angle, the supporting member 4 is provided in the form of the same right angle as the corner of the backplane 1, which makes the supporting member 4 and the backplane 1 to be better connected. Two adjacent side edges of each corner of the liquid crystal panel 3 have supporting points, so that the supporting member 4 has a better supporting effect on the liquid crystal panel 3 which is laid upon the supporting member 4. The right-angle supporting member 4 includes the first extension portion 41 and the second extension portion 42 which are respectively located adjacent to the two adjacent edge portions of the corner of the backplane 1.

Since the first extension portion 41 and the second extension portion 42 are respectively located on two adjacent edge portions of the corner of the backplane 1, the first extension portion 41 and the second extension portion 42 may be configured to fix the liquid crystal panel 3 and constrain the optical component group 2 within the space formed by the four supporting members 4. At this time, the liquid crystal panel 3 is constrained by the supporting members 4 in both lengthwise direction and widthwise direction of the backplane, e.g., the liquid crystal panel 3 is limited in a direction perpendicular to the thickness direction thereof, so that the liquid crystal panel 3 may not move in the direction perpendicular to the thickness direction thereof. Similarly, the optical component group 2 located inside the supporting members 4 is fixated by either the first extension portions 41 or the second extension portions 42 of the supporting members 4, so that the position of the optical component group 2 is constrained.

For ease of manufacture and installation, the first extension portion 41 and the second extension portion 42 of the supporting member 4 generally have the similar structure. To ensure that the first extension portion 41 and the second extension portion 42 have a sufficient bearing capacity for the liquid crystal panel 3, and reduce the sizes of the supporting members 4 so as to reduce cost, as shown in FIG. 5, lengths of both the first extension portion 41 and the second extension portion 42 may respectively be one tenth or one sixth of the width of the backplane 1. But it is without doubt that as far as the requirement for installation and usage of the supporting members 4 can be fulfilled, there should not be any limitation to the specific size of the supporting members 4.

In order to fix the supporting members 4 onto the backplane 1, the supporting members 4 may be attached to the backplane 1 in various detachable or non-detachable manners. In embodiments, the supporting members 4 and the backplane 1 may be snap-fitted.

As shown in the partial enlarged view in FIG. 5, the supporting members 4 and the backplane 1 are snap-fitted. A snapping portion is provided in the backplane 1 to snap or engage with the supporting member 4, and a corresponding portion is provided in the supporting member 4 to match the snapping portion of the backplane 1 in both position and shape. Such an arrangement ensures a firm attachment between the supporting members 4 and the backplane 1, so that the supporting members 4 are not detached from the backplane 1 easily.

In embodiments, at least one first snapping portion 43 is provided in the supporting member 4, and at least one second snapping portion 121 is provided in the side plane 12 to snap or engage with the corresponding first snapping portion 43. The second snapping portion 121 and the first snapping portions 43 are in one-to-one correspondence.

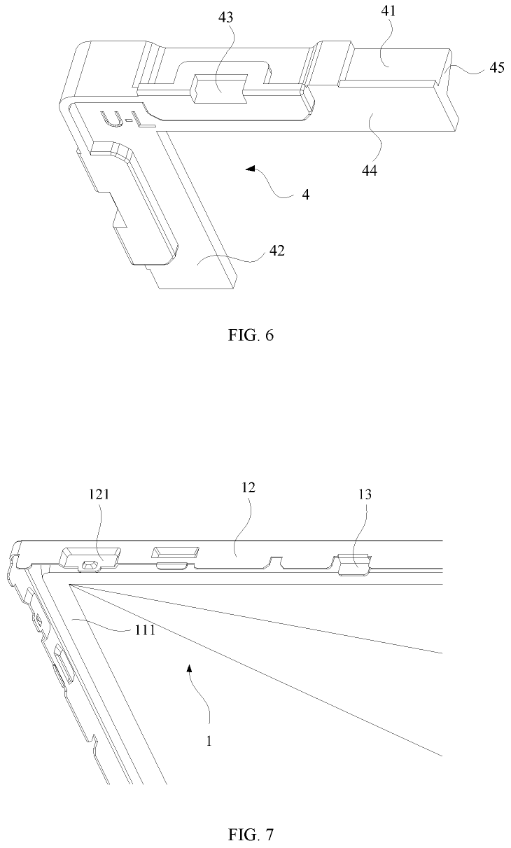

FIG. 6 is a schematic diagram of a structure of a supporting member according to embodiments of the present application. As shown in FIG. 6, a first snapping portion 43 is provided in the supporting member 4, and the side plane 12 in FIG. 7 is provided with a second snapping portion 121, which achieves the snap-fit connection between the supporting member 4 and the backplane 1. It should be noted that the number of the first snapping portions 43 is not limited. In the case of a single one first snapping portion 43, the first snapping portion 43 may be provided in the first extension portion 41 or the second extension portion 42, as long as a firm attachment between the supporting member 4 and the backplane 1 is ensured by snap-fit connection of the first snapping portion 43 and the second snapping portion 121. Naturally, by providing the first snapping portions 43 in both the first extension portion 41 and the second extension portion 42, it may be ensured that the supporting member 4 and the two adjacent side planes 12 of the corner of the backplane 1 are fixedly attached, and thus the attachment between the supporting member 4 and the backplane 1 may be stronger.

In this case, the attachment of the supporting members 4 and the backplane 1 may be realized by means of threaded fasteners or bonding method, and is not limited here.

FIG. 7 is a schematic diagram of a partial structure of a backplane according to embodiments of the present application. As shown in FIG. 7, the second snapping portion 121, which matches to the first snapping portion 43 in terms of position, size, shape and quantity, is provided in the side plane 12. The snap-fit connection of the supporting member 4 and the side plane 12 is realized by snapping or engaging the first snapping portion 43 with the second snapping portion 121.

In embodiments, the first snapping portion 43 may be a projection and the second snapping portion 121 may be a notch into which the projection is snapped; or, the first snapping portion 43 may be the notch and the second snapping portion 121 may be the projection snapped into and coupled with the notch. Notches and projections are easy to be made on the side plane 12 due to the thinness of the backplane 1, and notches and projections are also easy to be made on the supporting members 4. Therefore, the snap-fit connection of the supporting member 4 and the side plane 12 is easily realized by the first snapping portion 43 of the supporting member 4 which is the projection or the notch and the corresponding second snapping portion 121 of the side plane 12 which is the notch or the projection, thereby ensuring the reliability of the attachment of the supporting members 4 and the side plane 12. The shape and quantity of the first snapping portion and the second snapping portion are not limited in the application as long as the snap-fit connection is realized.

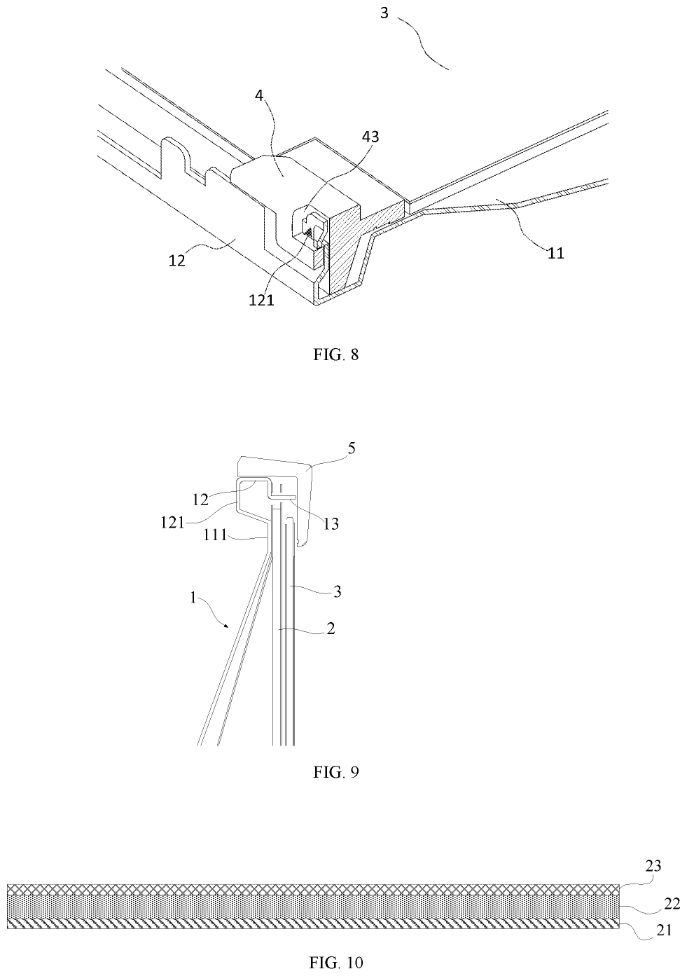

In embodiments, for example, the first snapping portion 43 is the notch and the second snapping portion 121 is the projection that is snapped into and coupled with the notch. FIG. 8 is a schematic diagram of a cross section of the snapping structure between the supporting member and the backplane according to embodiments of the present application. As shown in FIG. 8, the first snapping portion 43 of the supporting member 4 is the notch and the second snapping portion 121 of the backplane is the projection that matches the first snapping portion 43 of the supporting member 4 in terms of quantity, location and shape. The projection and the notch may be snap-fitted to each other to fixate the supporting member 4 to the backplane 1. It is without doubt that the first snapping portion 43 and the second snapping portion 121 as shown in FIG. 6, FIG.7 and FIG. 8 are merely an example in embodiments of the application. Other appropriate structures of the first snapping portion 43 and the second snapping portion 121 are not limited in the present application.

In order to firmly support the liquid crystal panel 3, in embodiments, the supporting member 4 includes a first settling surface 44 that faces toward the light emitting side of the display device, and the liquid crystal panel 3 is placed on the first settling surface 44.

As shown in FIG. 6, the supporting member 4 is provided with the first settling surface 44 located on the side of the supporting member 4 that faces toward the light emitting side of the display device. The first settling surface 44 is abutted against the liquid crystal panel 3, i.e., the four corners of the liquid crystal panel 3 are in contact with the first settling surfaces 44 of the supporting members 4. In order to make the supporting members 4 have a better fixing effect on the liquid crystal panel 3, in other words, the liquid crystal panel 3 is not moved on the first settling surfaces 44 under external interruption, e.g., external force, the shape of the corner of the liquid crystal panel 3 may be formed into match the shape of the first settling surface 44. As shown in FIG. 6, the first settling surface 44 has a position limiting portion to limit the movement of the liquid crystal panel. The shape of the first settling surface 44 of the supporting member shown in FIG. 6 is, for example, “concave shape”, and a corresponding portion of the liquid crystal panel 3 matches the “concave shape” configuration, thereby enabling the corner of the liquid crystal panel 3 to abut against the corresponding first settling surface 44.

FIG. 9 is a schematic diagram of a partial structure of a backplane according to embodiments of the present application. As shown in FIG. 9, due to a generally larger display area of display device, in order to achieve an entirely support for the optical component group 2, the protrusions 111 may be formed into a circular protrusion close to the side planes 12 on the backplane 1.

The protrusions 111 are abutted against a side of the optical component group 2 that away from the liquid crystal panel 3, and the protrusions 111 are configured to support the optical component group 2. The protrusions 111 are located on the edge portions of the backplane 1 which is close to the side planes, and are in contact with edges of a lowest component of the optical component group 2. FIG. 9 illustrates a structure of the protrusion 111 in one of the corners of the backplane 1, where each edge portion of the bottom plane 11 of the backplane has the protrusion 111 abutted against the optical component group 2. And, two protrusions 111 on the two adjacent edge portions may be joined together. The four protrusions 111 may be connected into a whole, thereby forming the circular protrusion. In embodiments, in order to meet the installation requirement of the display device, the protrusions 111 may be extended discontinuously in the extending directions of the side planes 12, for example.

In embodiments, the top end of the protrusion 111 is formed into a second settling surface for supporting the optical component group 2. As mentioned above, the top ends of the protrusions 111 are in contact with edges of the lowest component of the optical component group, i.e., the protrusions 111 are in contact with the edges of the surface of the lowest optical component. Therefore, the top ends of the protrusions 111 are formed into the second settling surfaces for abutting against the lowest optical component, which provides sufficient support for the optical components. In embodiments, the second settling surfaces are configured to support the optical component group 2 including the lowest optical component and various laminated optical components stacked upon the lowest component.

In order to provide additional support to the supporting member 4, in embodiments, a side portion of the supporting member 4 that is away from the side plane 12 may be on the second settling surface.

As shown in FIG. 2 and FIG. 6, the first settling surface 44 of the supporting member 4 is configured to support the liquid crystal panel 3. The other side surface of the supporting member 4 that is opposite to the first settling surface 44 is in contact with the upper surface, i.e., the second settling surface, of the protrusion 111. The second settling surface has a supporting effect on the side portion of the supporting member 4 that is away from the side plane 12, thus the supporting member 4 is supported.

It should be noted that the side portion of the supporting member 4 that is away from the side plane 12 is on the second settling surface. The edge portion of the optical component group 2 is also on the second settling surface. The liquid crystal panel 3 is provided on the first settling surface 44. The bottom surface of the optical component group 2 and a bottom surface of the side portion of the supporting member 4 that is away from the side plane 12 are in a same plane. Accordingly, the optical component group 2 is wholly located within the space formed by the four supporting members 4, which greatly reduces a gap between the liquid crystal panel 3 and the optical component group 2 and makes the thickness of the whole display device to become thinner.

In embodiments, the supporting member 4 includes a supporting portion 45 extended towards the bottom plane 11 of the display device and abutted against the bottom plane 11 of the backplane 1.

As shown in both FIG. 2 and FIG. 6, the supporting member 4 includes the supporting portion 45 extended towards the bottom plane 11 of the display device and abutted against the bottom plane 11 of the backplane 1. Since the backplane 1 includes the bottom plane 11 and side plane 12, the supporting portion 45 is abutted against the bottom surface of the bottom plane 11. The side plane 12 of the backplane 1 is an inward bending flange and the protrusion 111 is provided to be close to the side plane 12, thus, a portion of the backplane 1 that is between the side plane 12 and the protrusion 111 is formed into the concavity 112 for housing the supporting portion 45.

In embodiments, the thickness of the supporting portion 45 is matched with the width of the concavity 112, so that the supporting portion 45 may be embedded into the concavity 112, so as to achieve the fixation of the supporting members 4 and the backplane 1.

The side portion of the supporting member 4 that is away from the side plane 12 is fixed between the backplane 1 and the liquid crystal panel 3. For example, the side portion is between the protrusion 111 and the liquid crystal panel 3. Therefore, the supporting members 4 are more stable in the display device through the supporting effect of the bottom surface of the backplane 1 for the supporting portions 45.

In embodiments, the optical component group 2 includes a reflector 21, a diffusion plate 22, and multiple optical film sheets 23 provided sequentially from a back surface to a front surface of the display device.

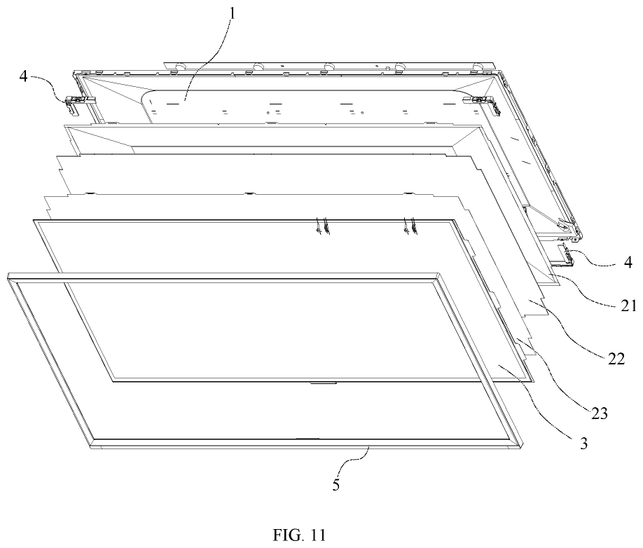

FIG. 10 is a schematic diagram of a structure of an optical component group according to embodiments of the present application. FIG. 11 is an exploded schematic diagram of a display device according to embodiments of the present application. As shown in FIG. 9 and FIG. 10, the optical components that are included in the optical component group 2 are sequentially the reflector 21, diffusion plate 22 and multiple optical film sheets 23 from the back surface to the front surface of the display device. In a direct type display device, light rays emitted from the light source are upwards and uniformly diffused by the diffusion plate 22, then the light rays passing through the multiple optical film sheets 23 are more uniform, and finally, irradiates toward the liquid crystal panel 3. Moreover, the optical component group 2 further includes other components such as the light emitting diodes (LEDs) used as the light source. As shown in FIG. 11, in order to keep away from the supporting members 4 on the corners of the backplane, corner portions of both the diffusion plate 22 and the optical film sheets 23 are formed into irregular structures.

In embodiments, hangers 13 are provided on the side plane 12 of the backplane 1. Through-holes through which the hangers 13 are passed are provided on the edge portions of the optical film sheets 23. The optical film sheets 23 are fixated on the backplane 1 through the hangers 13.

As shown in FIG. 9, the hangers 13 are provided on the side plane 12 of the backplane 1 to further limit the position of the optical film sheets 23. The hangers 13 are provided at positions of the side plane 12 which are slightly further away from the second snapping portions 121, which not affect the snap-fit connection of the supporting members 4 and the backplane 1. The structures of the hangers 13 as shown in FIG. 9 are protrusion structures extending inwardly on the side plane 12 of the backplane 1. Through-holes are provided at the positions of the optical film sheets 23 which are corresponding to the hangers 13, so as to enable the hangers 13 to pass through.

Since the optical film sheets 23 are the uppermost of the optical component group 2, the optical film sheets 23 are closest to the liquid crystal panel 3. But, the optical film sheets 23 are not in tight contact with the liquid crystal panel 3. So in order to avoid a relative displacement between the optical film sheets 23 and the diffusion plate 22, the optical film sheets 23 are fixed onto the backplane 1 by making the hangers 13 of the backplane 1 to pass through the through-holes of the optical film sheets 23.

In embodiments, the supporting members 4 may be made of plastic for ease of manufacture. Specifically, the supporting members 4 may be made of plastic, preferably hard plastic, to ensure a stationarity of the structure of the supporting members 4, thereby ensuring the limitative effect on the optical component group 2 and the supportive effect on the liquid crystal panel 3.

Moreover, the supporting members are made of the plastic material that may be the same as the material of the conventional rubber frame. And since the supporting members 4 only occupy four corners of the backplane 1, there is much less material than the rubber frame 300, which effectively reduces the cost of manufacture of the display device. Besides, the supporting members 4 are attached to the backplane 1 through the snap-fit connection, and no crumbs will emerge due to the fraction between the rubber frame 300 and the backplane 1 during installation. Since the supporting members 4 are small in size, the supporting members 4 are more easily engaged with the backplane 1. Compared with the rubber frame 300, the supporting members 4 not only reduce the overall thickness of the display device but also increase the quality and productiveness of the display device.

Finally, in embodiments, a specific method that calculates a minimal thickness of the display device is provided. As shown in FIG. 2, the minimal thickness of the display device is a distance from the bottom surface of the protrusion 111 to the upper surface of the liquid crystal panel 3. For example, the thickness of the backplane 1 is 0.5 mm, the thickness of the reflector 21 is 0.2 mm, the thickness of the diffusion plate 22 is 1.2 mm, the thickness of the optical film sheets 23 is 0.2 mm, the gap between the optical component group 2 and the liquid crystal panel 3 is 0.3 mm, and the thickness of the liquid crystal panel 3 itself is 1.3 mm. Based on these values, the minimal thickness of the display device is a sum of the thickness of the backplane, the thickness of the reflector, the thickness of the diffusion plate, the thickness of the optical film sheets, the thickness of the gap, and the thickness of the liquid crystal panel, i.e., D=0.5+0.2+1.2+0.2+0.3+1.3=3.7 mm, where D represents the minimal thickness of the backlight module of the display device.

In embodiments, the display device includes the backplane, the optical component group, the liquid crystal panel, and supporting members. The optical component group includes a plurality of optical components laminated, and the optical component group is provided between the liquid crystal panel and the backplane. The backplane includes the bottom plane and the side planes respectively extended from the edge of the bottom plane to the side of the bottom plane. The supporting members are provided in at least two corners of the backplane, and the liquid crystal panel is disposed on a side of the supporting members that is away from the bottom plane. By disposing supporting members in at least two corners of the backplane, the liquid crystal panel is supported and fixed, thereby reducing the thickness of the backlight module in the display device. So, the thickness of the display device is less.

Finally, it should be noted that the above examples are merely intended to illustrate the technical solutions of the present disclosure rather than to limit the present disclosure. Although the present disclosure is described in detail with reference to the aforesaid examples, those of ordinary skill in the art should understand that modifications can still be made to the technical solutions contained in the different examples as described above or equivalent substitutions can still be made to some technical features therein. These modifications or substitutions will not cause the nature of the corresponding technical solutions to depart from the spirit and scope of the technical solutions of the different examples of the present disclosure.

What is claimed is:

1. A display device, comprising:
a backplane comprising:
a bottom plane; and
a plurality of side planes, wherein each of the plurality of side planes extends from an edge of the bottom plane to a side of the bottom plane;
a plurality of supporting members in at least two corners of the backplane;
a liquid crystal panel positioned on a side of the plurality of supporting members that is non-adjacent to the bottom plane; and
an optical component group comprising a plurality of laminated optical components, and the optical component group being disposed between the liquid crystal panel and the backplane.

2. The display device according to claim 1, wherein:
the plurality of supporting members include four supporting members;
the backplane comprises four corners; and
the four supporting members are arranged in an one-to-one correspondence with the four corners of the backplane.

3. The display device according to claim 1, wherein each supporting member included in the plurality of supporting members includes a first extension portion and a second extension portion respectively provided on two adjacent edge portions of the backplane.

4. The display device according to claim 1, wherein the plurality of supporting members and the backplane are snap-fitted together.

5. The display device according to claim 4, wherein
each of the plurality of supporting members comprises at least one first snapping portion; and
each of the plurality of side planes comprises at least one second snapping portion, wherein the second snapping portion is configured to couple with the corresponding first snapping portion.

6. The display device according to claim 5, wherein:
the first snapping portion comprises a projection portion; and
the second snapping portion corresponding to the first snapping portion comprises a notch portion configured to couple with the projection portion.

7. The display device according to claim 5, wherein:
the first snapping portion comprises a notch portion; and
the second snapping portion corresponding to the first snapping portion comprises a projection portion configured to couple with the notch portion.

8. The display device according to claim 1, wherein the optical component group comprises a reflector, a diffusion plate and at least one optical film sheet provided sequentially from a back surface to a front surface of the display device.

9. The display device according to claim 8, wherein:
at least two of the plurality of side planes each include a respective hanger; and
edge portions of each of the at least one optical film sheet include a through-hole through which the respective hanger passes through.

10. A display device, comprising:
a backplane comprising:
a bottom plane; and
a plurality of side planes, wherein each of the plurality of side planes extends from an edge of the bottom plane to a side of the bottom plane;
a plurality of supporting members in at least two corners of the backplane;
a liquid crystal panel on a side of the plurality of supporting members that is away from the bottom plane;
an optical component group comprising a plurality of laminated optical components, and the optical component group being disposed between the liquid crystal panel and the backplane; and
wherein the bottom plane comprises:
protrusions close to the plurality of side planes, wherein the protrusions are protruded toward a light emitting side of the optical component group, and the protrusions are configured to support the optical component group.

11. The display device according to claim 10, wherein:
the plurality of supporting members include four supporting members;
the backplane comprises four corners; and
the four supporting members are arranged in an one-to-one correspondence with the four corners of the backplane.

12. The display device according to claim 10, wherein each supporting member included in the plurality of supporting members includes a first extension portion and a second extension portion respectively provided on two adjacent edge portions of the backplane.

13. The display device according to claim 10, wherein the plurality of supporting members and the backplane are snap-fitted together.

14. The display device according to claim 13, wherein:
each of the plurality of supporting members comprises at least one first snapping portion; and
each of the plurality of side planes comprises at least one second snapping portion, wherein the second snapping portion is configured to couple with the corresponding first snapping portion.

15. The display device according to claim 14, wherein:
the first snapping portion comprises a projection portion, and the second snapping portion corresponding to the first snapping portion comprises a notch portion configured to couple with the projection portion; or
the first snapping portion comprises the notch portion, and the second snapping portion corresponding to the first snapping portion comprises the projection portion configured to couple with the notch portion.

16. The display device according to claim 10, wherein each supporting member included in the plurality of supporting members comprises a supporting portion extended to the bottom plane of the display device and abutted against the bottom plane of the backplane.

17. The display device according to claim 16, wherein the supporting portion is embedded into a concavity in the bottom plane, wherein the concavity is between each of the protrusions and a corresponding one of the side planes.

18. The display device according to claim 10, wherein the optical component group comprises a reflector, a diffuser plate and at least one optical film sheet provided sequentially from a back surface to a front surface of the display device.

19. The display device according to claim 18, wherein:
at least two of the plurality of side planes each include a respective hanger; and
edge portions of each of the at least one optical film sheet include a through-hole through which the respective hanger passes through.

20. The display device according to claim 10, wherein a side portion of each supporting member included in the plurality of supporting members that is close to the bottom plane is on a corresponding one of the protrusions.
